(19) United States
(12) Patent Application Publication
(10) Pub. No.: US 2005/0274816 A1
(43) Pub. Date: Dec. 15, 2005

(54) Multi-functional pot with water spray function and light effect

(76) Inventor: Jen Yen Yen, Chang Hua Hsien (TW)

Correspondence Address: JEN YEN YEN, 235 CHUNG-HO BOX 8-24, TAIPEI HSIEN, 235, TW

(21) Appl. No.: 10/867,551

(22) Filed: Jun. 11, 2004

(51) Int. Cl. B05B 17/08

(52) U.S. Cl. 239/17; 239/23

(57) ABSTRACT

A multi-functional pot comprises a lower pot body, a spray ring, a pump, a supporting seat, and an upper pot body. A lower pot body has a positioning seat at a bottom thereof and the positioning seat has a via hole. The pump is installed on the positioning seat. The spray ring is a hollow ring and is placed in the lower pot body. A lower end of the spray ring has a water inlet tube which is connected to a soft tube. The soft tube is then connected to the pump. A soft tube of the pump passes through the upper via hole. A cotton strip is protruded out to be in the basin. The cotton strip absorbs water in the lower pot body to provide the water to the plants in the upper pot body.

### FIELD OF THE INVENTION

The present invention relates to pots, and particular to a multi-functional pot with water spray function and light effect

### BACKGROUND OF THE INVENTION

The prior art water spray pot purely sprays water to spray plants in the pot. The prior art pot has no function of light effect so that it presents a dull outlook.

### SUMMARY OF THE INVENTION

Accordingly, the primary object of the present invention is to provide a multi-functional pot comprises a lower pot body, a spray ring, a pump, a supporting seat, and an upper pot body. A lower pot body has a positioning seat at a bottom thereof and the positioning seat has a via hole. The pump is installed on the positioning seat. The spray ring is a hollow ring and is placed in the lower pot body. A lower end of the spray ring has a water inlet tube which is connected to a soft tube. The soft tube is then connected to the pump. A soft tube of the pump passes through the upper via hole. One end of the cotton strip is protruded out to be in the basin. The cotton strip absorbs water in the lower pot body to provide the water to the plants in the upper pot body.

The various objects and advantages of the present invention will be more readily understood from the following detailed description when read in conjunction with the appended drawing.

### BRIEF DESCRIPTION OF THE DRAWINGS

FIG. 1 is an exploded perspective view and partial cross section view of the present invention.

FIG. 2 is an assembled perspective view of the present invention.

FIG. 3 is an assembled cross section view of the present invention.

FIG. 4 shows another embodiment of the present invention, where more water is contained in the pot of the present invention

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

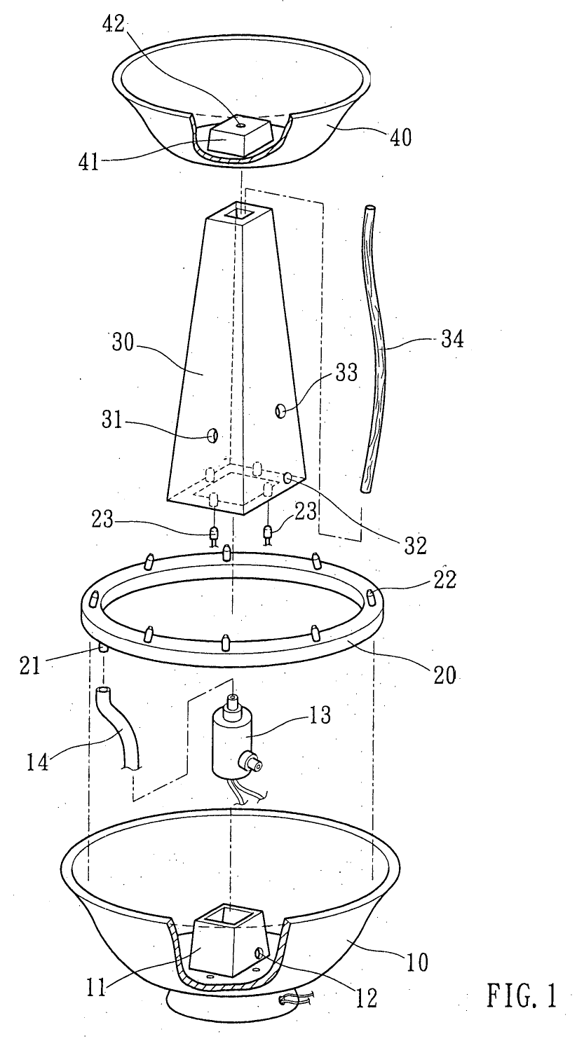

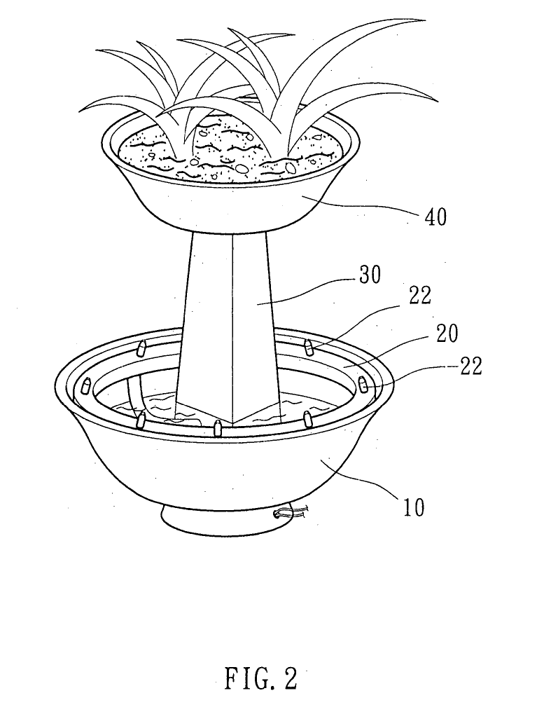

With reference to FIGS. 1, 2 and 3, the present invention includes a lower pot body 10, a spray ring 20, a pump 13, a supporting seat 30, and an upper pot body 40.

The lower pot body 10 has a positioning seat 11 at a bottom thereof and the positioning seat 11 has a via hole 12. The pump 13 is installed on the positioning seat 11. A power wire of the pump 13 passes out of the lower pot body 10. The connection of the power wire of the pump 13 and the lower pot body 10 are tightly sealed for water-proof.

The spray ring 20 is a hollow ring and is placed in the lower pot body 10. A lower end of the spray ring 20 has a water inlet tube 21 which is connected to a soft tube 14. The soft tube 14 is then connected to the pump 13 so that water in the lower pot body 10 is pumped to the spray ring 20. An upper surface of the spray ring 20 is distributed with a plurality of spray tubes 22 which are communicated to one another. Water is sprayed out from the spray tubes 22.

The supporting seat 30 is a hollow seat 30. The supporting seat 30 has an upper via hole 31, a lower via hole 32 and a through hole 33. A bottom end of the supporting seat 30 is fixed to (stuck to) a positioning seat 11 of the lower pot body 10. The soft tube 14 of the pump 13 passes through the upper via hole 31. Water in the lower pot body 10 can flow through the lower via hole 32 to the positioning seat 11 to be further pumped by the pump 13. Moreover, the supporting seat 30 is transparent. A lower end of the supporting seat 30 has a plurality of slots for assembling LED lamps 23. The LED lamps 23 are connected to the power source of the pump so that the supporting seat 30 has an effect of illumination.

The upper pot body 40 has an embedding seat 41 at a center of the bottom thereof. A bottom surface of the embedding seat 41 is correspondent to the groove at an upper end of the supporting seat 30 so as to be engaged to the supporting seat 30. Moreover, the embedding seat 41 of the upper pot body 40 has a via hole 42 for assembling a water absorbing cotton strip 34, thereby, the supporting seat 30 supporting the upper pot body 40. Plants can be planted in the upper pot body 40. One end of the cotton strip 34 is protruded out to be in the basin and another end of the cotton strip 34 passes through the supporting seat 30 and then passes into the lower pot body 10 from the through hole 33, hence the cotton strip 34 can absorb water in the lower pot body 10 to provide the water to the plants in the upper pot body 40.

The application and effect of the present invention will be described here.

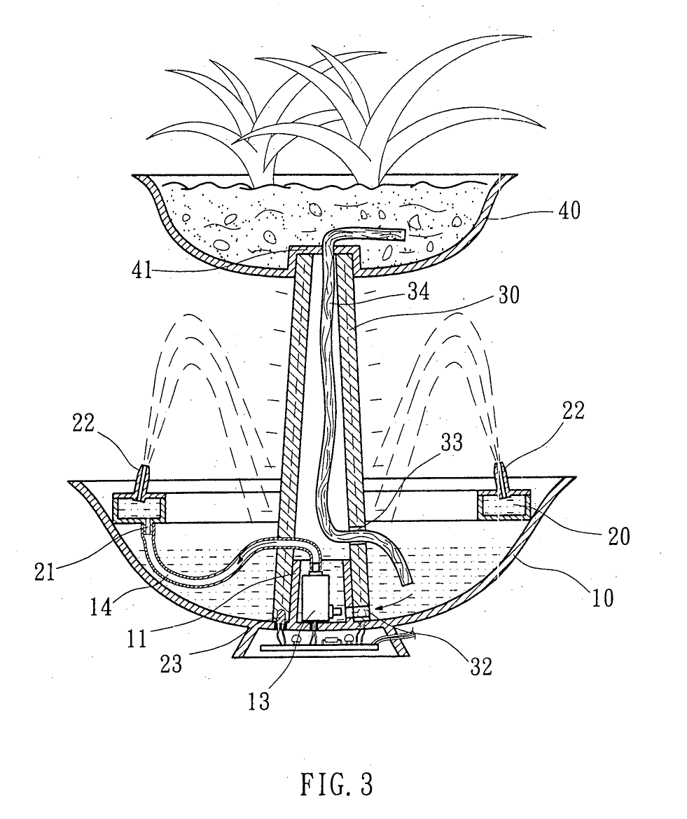

Referring to FIG. 3, water is filled into the lower pot body 10. Plants are planted in the upper pot body 40. When power is on, the LED lamps 23 will light up. Since the supporting seat 30 is transparent, the supporting seat 30 likes a post lamp so as to have a beautiful effect. When the pump 13 is not powered, water in the lower pot body 10 will be pumped out. The water flows through the soft tube 14, the water inlet tube 21 of the spray ring 20 to be inputted into the spray ring 20. Then water is sprayed out from the spray tubes 22 of the spray ring 20 so as to spray water with a beautiful dynamic pattern. The spraying water flows into the lower pot body 10 to flow through the via hole 32 of the supporting seat 30, and the via hole 12 of the positioning seat 11 of the lower pot body 10 to be used by the pump 13. Furthermore, the cotton strip 34 in the upper pot body 40 extends to the lower pot body 10. The cotton strip 34 can absorb water to be provided to the upper pot body 40. In other words, when earth for planting is dry, the water in the cotton strip 34 can be absorbed. Then the cotton strip 34 will further absorb the water in the lower pot body 10. When the soil is wet, the cotton strip 34 will not absorb water further. Thereby, the plants in the upper pot body 40 has water supply from the cotton strip 34.

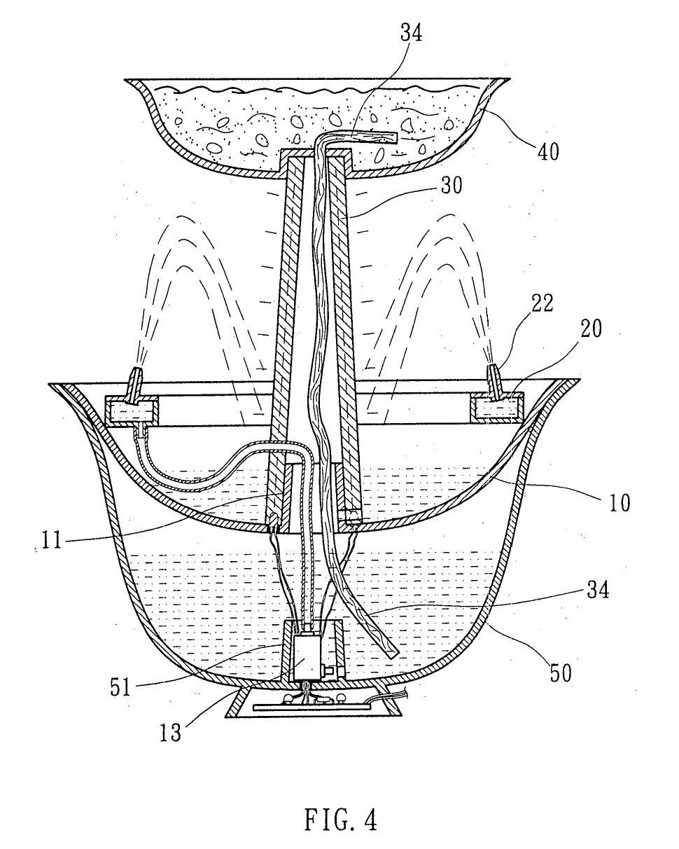

Furthermore, in the present invention, to have more water to be stored in the lower pot body 10 so that water supplied to the upper pot body 40 can be retained with a longer time, as shown in FIG. 4, a bottom pot 50 is assembled below the lower pot body 10. A receiving seat 51 is installed in the bottom pot 50 for placing the pump 13. The positioning seat 11 of the supporting seat 30 of the lower pot body 10 is communicated to the bottom seat so that the pump 13 and the cotton strip 34 can be passed to the bottom pot 50 for pumping and absorbing water. Thereby, more water is provided to the plants in the upper pot body 40.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A multi-functional pot comprising a lower pot body, a spray ring, a pump, a supporting seat, and an upper pot body; wherein
the lower pot body has a positioning seat at a bottom thereof and the positioning seat has a via hole; the pump is installed on the positioning seat; a power wire of the pump passes out of the lower pot body; the connection of the power wire of the pump and the lower pot body is tightly sealed for water-proof;
the spray ring is a hollow ring and is placed in the lower pot body;
a lower end of the spray ring has a water inlet tube which is connected to a soft tube; the soft tube is then connected to the pump so that water in the lower pot body is pumped to the spray ring; an upper surface of the spray ring is distributed with a plurality of spray tubes;
the supporting seat is a hollow seat; the supporting seat has an upper via hole, a lower via hole and a through hole; a bottom end of the supporting seat is fixed to a positioning seat of the lower pot body; the soft tube of the pump passes through the upper via hole; water in the lower pot body flows through the lower via hole to the positioning seat to be used to the pump; and
the upper pot body has an embedding seat at a center of the bottom thereof; a bottom surface of the embedding seat is correspondent to a groove at an upper end of the supporting seat so as to be engaged to the supporting seat; the embedding seat of the upper pot body has a via hole for assembling a water absorbing cotton strip, thereby, the supporting seat supporting the upper pot body; plants can be planted in the upper pot body; one end of the cotton strip is protruded out to be in the basin and another end of the cotton strip passes through the supporting seat and then passes into the lower pot body from the through hole, hence the cotton strip absorbs water in the lower pot body to provide the water to the plants in the upper pot body.

2. The multi-functional pot as claimed in claim 1, wherein the supporting seat is transparent; a lower end of the supporting seat has a plurality of slots for assembling LED lamps; the LED lamps are connected to the power source of the pump so that the supporting seat has an effect of illumination.

3. The multi-functional pot as claimed in claim 1, wherein a bottom pot is assembled below the lower pot body; a receiving seat is installed in the bottom pot for placing the pump; the positioning seat of the supporting seat of the lower pot body is communicated to the bottom seat so that the pump and the cotton strip is passed to the bottom pot for pumping and absorbing water; thereby, more water is provided to the plants in the upper pot body.
